(19) United States
(12) Patent Application Publication
(10) Pub. No.: US 2003/0070927 A1
(43) Pub. Date: Apr. 17, 2003

(54) Reagents and methods for fluorescent analysis of serum proteins

(76) Inventors: Mark E. Merchant, Nederland, TX (US); Philip A. Guadagno, Vidor, TX (US); Debra Linn Hicks, Orange, TX (US); Suzan Sha Robinson, Beaumont, TX (US)

Correspondence Address: Supervisor, Patent Prosecution Services, PIPER RUDNICK LLP, 1200 Nineteenth Street, N.W., Washington, DC, 20036-2412, US

(21) Appl. No.: 10/247,374

(22) Filed: Sep. 20, 2002

Related U.S. Application Data
(63) Continuation of application No. 09/230,241, filed on Sep. 16, 1999, now abandoned.
Application No. 09/230,241 is a 371 of international application No. PCT/US97/13320, filed on Jul. 23, 1997.
(60) Provisional application No. 60/022,356, filed on Jul. 24, 1996.

(51) Int. Cl. G01N 27/26

(52) U.S. Cl. 204/461; 8/506; 8/516; 8/636; 8/648; 8/658

(57) ABSTRACT

Methods and reagents for fluorescent analysis of serum proteins separated by electrophoresis. This assay allows for the immediate quantitation of resolved proteins in biological materials. The electrophoresed sample is treated with a fixative composition and stained using an ANS-based stain solution. No pre-stain washing or post-stain washing and drying is required. The fluorescent serum protein assay allows for automation of serum protein analyses.

### RELATED APPLICATIONS

This application claims the priority of U.S. Provisional Application No. 60/022,356, filed Jul. 24, 1996, which is incorporated herein by reference.

### FIELD OF THE INVENTION

The present invention relates to reagents and methods for fluorescent analysis of serum proteins. It has particular application in the medical and laboratory diagnostic fields where it is necessary to perform testing and analysis of biological and chemical substances.

### BACKGROUND OF THE INVENTION

Electrophoresis is well known as a technique for separating components of a biological sample by placing the biological sample on a carrier and subjecting the biological sample to the influence of an electrical potential. A number of methods and reagents currently exist for serum protein electrophoresis procedures.¹ ¹ One such conventional procedure marketed by Helena Laboratories Corporation is a serum protein electrophoresis procedure utilizing a cellulose acetate plate which is sold as “Titan® III, cellulose acetate membrane-serum proteins.”

The particles migrate on the carrier (plate) based upon various factors such as size (molecular mass) and electrical charge of the particles. After the separation has taken place, the particles are frequently stained so that they become visible when exposed to a particular wavelength of electromagnetic radiation. Thereafter, using equipment such as scanning densitometers, quantitative analysis may be achieved relative to the separated constituents of the biological sample.

In the case of serum proteins, it should be appreciated that human serum contains over 100 individual proteins, each with a specific set of functions and subject to specific variations in concentration under different pathological conditions. When electrophoresis of serum proteins occurs, the proteins have been fractionated or separated on the basis of their electrical charges into five classical fractions: albumin, alpha-1, alpha-2, beta, and gamma. Each of these fractions, with the exception of albumin, normally contain two or more components.

After the electrophoresis step, some prior art methods require the electrophoresed plate to be treated with a fixative. The word “fixative” as used herein means any agent that will inhibit the diffusion of proteins. Thereafter, the prior art techniques require a staining procedure that typically includes washing and/or drying steps, so that the electrophoresed or separated proteins can be “visualized”, i.e., will be “visible” when exposed to the appropriate wavelength of electromagnetic radiation.

Through the use of stains, the separated proteins become visible whether to the naked eye or in response to an excitation wavelength. However, when cellulose acetate plates are used, for example, the entire plate appears to be the color of the stain. Thus it is common to destain or wash the electrophoresis plate to remove the stain from areas of the plate where no proteins are found. This may be achieved such that the background plate is white or transparent depending upon subsequent steps to be utilized in the process. It is often necessary to dry the electrophoresis plate after washing it when using certain types of stains before the electrophoresed or separated proteins can be “visualized.”

For additional background relating to reagents and methods for the fluorescent analysis of proteins in gels, including anilinonaphthalene-sulfonate-mediated fluorescent analysis, the following disclosures are noted and are hereby incorporated by reference: (1) “Ion-Enhanced Fluorescence Staining of Sodium Dodecyl Sulfate-Polyacrylamide Gels Using Bis(8-p-toluidino-1-naphthalenesulfonate),” Horowitz et al, Analytical Biochemistry 165, pages 430-434 (1987); (2) “Serum Proteins”, A Clinical Laboratory Procedure by G. K. Turner Associates, Inc., (3) “A fluorescent method for rapid staining and quantitation of proteins in sodium dodecyl sulfate-polyacrylamide gels”, Aragay et al, Electrophoresis 1985, 6, 527-531; and (d) FluorKit Pro-1, 1-D Protein Staining System, by Molecular Dynamics.

### SUMMARY OF THE INVENTION

The present invention provides improved methods and staining reagents for quantitative analysis of proteins separated by electrophoresis. The proteins are stained and excited to fluoresce for quantitative analysis while the electrophoretic plate is still wet, thus eliminating the “wash” and “dry” steps of conventional methods and staining reagents.

The invention encompasses a hydrophobic stain composition comprising a mixture of a nonspecific, hydrophobic, fluorescent dye and a fixative. The fluorescent dye of an embodiment of the invention is selected from the anilinonaphthalene-sulfonate family of dyes. The fixative comprises:

(1) tannic acid;

(2) at least one additional acid that will cause proteins to denature and precipitate, and that is compatible with electrophoretic gels; and

(3) an anti-drying agent.

Two acids that will denature proteins and cause them to precipitate are sulfosalicylic acid and acetic acid.

Another embodiment of the invention encompasses a hydrophobic stain composition that comprises a mixture of a nonspecific, hydrophobic, fluorescent dye and a fixative that comprises:

(1) sulfosalicylic acid;

(2) acetic acid;

(3) tannic acid; and

(4) an anti-drying agent.

The invention further encompasses a method for fluorescent analysis of serum proteins on a electrophoretic plate comprising:

(1) separating proteins electrophoretically;

(2) staining the separated proteins while wet with a composition comprising a hydrophobic fluorescent dye and a fixative; and

(3) exciting the stained proteins with an appropriate wavelength of light; and

(4) scanning the exited proteins with a densitometer having fluorometric capabilities.

### DETAILED DESCRIPTION OF THE INVENTION

The methods and reagents of the invention provide for inexpensive, quick and time efficient fluorescent analysis of serum proteins. The invention enables users to analyze electrophoretic plates stained with a fluorometric dye without the conventional pre- and post-staining washing and drying steps. Because these washing and drying steps can be eliminated, a user can electrophorese plates and then stain and fluorometrically analyze them in significantly, less time using automated systems.

Any conventional electrophoresis instrument can be used to practice the present invention. In practicing the preferred embodiment described below, Helena Laboratories Corporation's Rapid ElectroPhoresis (REP®) and Rapid ElectroPhoresis 3 (REP® 3) instruments have been used. The REP® instrument and the use of this instrument are described in U.S. Pat. Nos. 4,810,348 and 4,909,920, which are hereby incorporated by reference. The REP® 3 instrument is similar to the REP® instrument, but includes an in situ fluorescent scanner. The REP® 3 instrument and the use of this instrument are described in commonly assigned copending application Ser. No. ______ (Attorney Docket No. 5043), filed May 1, 1997, which is hereby incorporated by reference.

The preferred embodiment of the present invention utilizes an agarose gel matrix or plate which is electrophoresed under native conditions, i.e., no protein denaturant is added. In addition to the agarose, the gel used includes a tris base, salicylic acid, glycerol, sorbitol with sodium azide and thimerosal as preservatives and an electrophoresis buffer system, preferably sodium barbital at a pH range of 8.4 to 10.2. In the preferred embodiment the sodium barbital gel has a pH of approximately 8.6. Utilizing a Helena Laboratories Corporation Rep® Electrophoresis system, the sample is electrophoresed at 650 volts at 6.5 minutes at 21° C. It should be understood that other analyzers and systems will likely require different conditions for optimizing the assay.

After the electrophoresis step, the stain or reagent of the present invention is applied to the wet plate in a conventional manner. The reagent consists of a mixture of two solutions; a nonspecific, hydrophobic, fluorescent dye solution and a fixative solution. The fixative of the invention not only inhibits diffusion, but, in addition, causes the electrophoresed proteins to denature and precipitate in place so that they do not wash out. When denatured the hydrophobic sites of a protein are exposed providing hydrophobic microcell environments within the aqueous macroenvironment of the wet plate. When bound to the hydrophobic sites on the protein, the dye is in a molecular conformation which allows for fluorescence when excited with an appropriate energy.

In the preferred embodiment, the dye and fixative are stored separately. The fluorescent dye solution of the preferred embodiment consists of 8-anilinonaphthalene-1-sulfonate (ANS) in dimethylsulfoxide. The dimethylsulfoxide functions as a chemical stager to stage or aid in dissolving hydrophobic substances in a hydrophilic solution. ANS is a nonspecific, hydrophobic, fluorescent dye which interacts with the a polar regions of proteins. Because of its chemical nature ANS will not fluoresce when it is in a hydrophilic environment. Its capacity to fluoresce is dependent on being in a hydrophobic environment. It should be understood that other members of the ANS family, such as 2-anilinonaphthalene-8-sulfonate, 1-anilinonaphthalene-4-sulfonate, and 5-anilinonaphthalene-2-sulfonate conformers could be used in place of 8-anilinonaphthalene-1-sulfonate. Other families of hydrophobic fluorescent dyes could be used such the dansyl family of dyes. It should be understood that the different salts of the above identified hydrophobic dyes could be used.

One preferred embodiment of the fixative component consists of 10% sulfosalicylic acid (weight by volume), 5% acetic acid (volume by volume), 5% glycerol (volume by volume), and 1% tannic acid (weight by volume). Optionally 2% dimethylsulfoxide (DMSO) (volume by volume) can be added to the fixative component. DMSO increases the solubility of ANS in the fixative solution, and aids in extending the shelf life of the stain. The glycerol ingredient of the fixative component is added to prevent the finished or electrophoresed plate from drying and thus prevents or reduces background fluorescence.² Based on use of the REP® 3 under laboratory conditions, it is estimated that the addition of glycerol to the fixative extends the useful life of the plates from about 5 minutes³ to up to 15 minutes for the majority of plates. Other anti-drying agents which be used include sucrose, ficoll, polyethylene glycol, and a wide variety of high molecular weight polysaccharides. ² Because of its chemical nature, the capacity of ANS to fluoresce significantly increases when in a hydrophobic environment. ³ Five (5) minutes is the approximate wet life span of a plate that has not been “fixed” with glycerol or an equivalent anti-drying agent.

A working reagent is made by adding 100 μL of dye solution to 5 mL of fixative solution and mixing thoroughly by shaking vigorously. This mixture is stable at 15-30° C. for 1 hour. Thus, upon mixing, the stain of the most preferred embodiment consists of a solution of 100 μM ANS fluorescent dye, 10% sulfosalicylic acid (weight by volume), 5% acetic acid (volume by volume), 5% glycerol (volume by volume), 1% tannic acid (weight by volume), and 2% dimethylsulfoxide (DMSO) (volume by volume). The pH of the solution is less than 2.0. It is the pH of the solution that causes the proteins to unfold thereby exposing their hydrophobic regions and binding to ANS. Therefore, a higher pH could be used, provided the pH is acidic enough to cause the proteins of interest to unfold and precipitate.

The proteins are stained by immersing the gel plate in the solution, or spreading a layer of the solution over the gel plate, and allowing the reagent to react with the electrophoresed proteins for two minutes at the slightly elevated temperature of 30° C. It is contemplated that any interaction of the electrophoresed serum proteins with the reagent for a reasonable period of time will be sufficient for staining the proteins.

No “wash” is required before the staining, and no “wash” is required after the staining. Because the stained proteins of the present invention must be subjected to excitation while the plate is wet, there is no “drying” step. Should the plate be allowed to dry, the background will fluoresce along with the serum proteins for the reason noted above. Thus the present invention requires scanning of a “wet” electrophoretic plate. The stained fractions or sample using ANS-mediated dyes will fluoresce in response to a range of wavelengths. Those ranges will vary depending on the salt of the ANS dye used. For example, as provided by L. Stryer, in an article entitled: “The Interaction of a Naphthalene Dye with Apomyoglobin and Apohemoglobin: A Fluorescent Probe of Non-Polar Binding Sites,” J. Mol. Biol. 13:482-495 (1965), which is hereby incorporated by reference, a magnesium salt of ANS has a range of less than 320 nm to 420 nm, with a peak wavelength of 356 nm. It should be understood that other hydrophobic, fluorescent dyes will likely respond to different wavelengths. Quantitation of the fluorescent patterns has been obtained using the in situ scanner on Helena Laboratories Corporation's REP® 3, but any densitometer with fluorometric capability can be used.

### EXAMPLE

Helena Laboratories Corporation's Rep® 3 instrument (which includes an in situ fluorescent scanner), has been used with the methods and reagents of the present invention to analyze serum proteins. The stain used to analyze the proteins consisted of a solution of 100 μM ANS fluorescent dye, 10% sulfosalicylic acid (weight by volume), 5% acetic acid (volume by volume), 5% glycerol (volume by volume), 1% tannic acid (weight by volume), and 2% dimethylsulfoxide (DMSO) (volume by volume). Using this stain with the above described methods 60 serum protein analyses were completed in approximately 20 minutes using an automated system.

What is claimed is:

1. A reagent for staining proteins for fluorometric analysis, said reagent comprising a hydrophobic dye composition and a fixative composition capable of denaturing proteins.

2. The reagent of claim 1, wherein said fixative composition comprises:
(a) tannic acid; and
(b) at least one additional acid capable of causing serum proteins to precipitate.

3. The reagent of claim 2, wherein said at least one additional acid includes sulfosalicylic acid and acetic acid.

4. The reagent of claim 2, wherein said fixative further comprises an anti-drying agent.

5. The reagent of claim 3, wherein said hydrophobic dye composition comprises 8-anilinonaphthalene-1-sulfonate in dimethylsulfoxide.

6. A stain composition containing a mixture of Solutions I. and II. in which:
Solution I. comprises:
(a.) a hydrophobic dye;
(b.) a solubility stager and
Solution II. comprises:
(a.) 10 percent sulfosalicylic acid (weight by volume);
(b.) 5 percent acetic acid (volume by volume);
(c) 1 percent tannic acid (weight by volume); and
(d) an anti-dying agent.

7. The stain composition of claim 6, wherein the anti-drying agent is a member of the group consisting of glycerol, sucrose, ficoll, polyethylene glycol, and high molecular weight polysaccharides.

8. The stain composition of claim 7, wherein Component II. further comprises 2 percent dimethylsulfoxide (volume by volume), and said solubility stager is dimethylsulfoxide.

9. The stain composition of claim 8, wherein the pH of the solution is less than 2.0.

10. The stain composition of claim 9, wherein the hydrophobic dye is 8-anilinonaphthalene-1-sulfonate.

11. A method for fluorescent analysis of serum proteins on a electrophoretic plate comprising:
separating proteins electrophoretically;
staining the separated proteins while wet with a composition comprising a hydrophobic fluorometric dye and a fixative; and
exciting the stained proteins with an appropriate wavelength of light; and
scanning the exited proteins using a densitometer with fluorometric capabilities.

12. The method of claim 11, wherein the fluorometric dye consists of 8-anilinonaphthalene-1-sulfonate in dimethylsulfoxide.

13. The method of claim 12, wherein the fixative comprises acetic acid, sulfosalicylic acid, tannic acid, and an anti-drying agent.

14. The method of claim 13, wherein the anti-drying agent is a member of the group consisting of glycerol, sucrose, ficoll, polyethylene glycol, and high molecular weight polysaccharides.

15. The method of claim 14, wherein the fixative further includes dimethylsulfoxide.

16. A method for fluorescent analysis of serum proteins on a wet electrophoretic plate comprising:
separating proteins electrophoretically;
staining the separated proteins while wet with a composition comprising a hydrophobic fluorometric dye and a fixative including an anti-drying agent and being in solution with a pH of less than 2.0; and
exciting the stained proteins while the electrophoretic plate is still wet with an appropriate wavelength of light; and
scanning the exited proteins while the electrophoretic plate is still wet with a densitometer with fluorometric capabilities.
